(19) United States
(12) Patent Application Publication
(10) Pub. No.: US 2004/0019488 A1
(43) Pub. Date: Jan. 29, 2004

(54) Email address recognition using personal information

(75) Inventor: Pilar Manchon Portillo, Sevilla (ES)

Correspondence Address: FLEIT, KAIN, GIBBONS, GUTMAN, BONGINI, & BIANCO P.L., ONE BOCA COMMERCE CENTER, 551 NORTHWEST 77TH STREET, SUITE 111, BOCA RATON, FL, 33487, US

(73) Assignee: NetByTel, Inc., Boca Raton, FL

(21) Appl. No.: 10/201,178

(22) Filed: Jul. 23, 2002

(51) Int. Cl. G10L 21/00

(52) U.S. Cl. 704/275

(57) ABSTRACT

A system, method and computer program product is provided for the automated voice recognition of an email address of a user. According to the method, speech representing the email address of the user is received, personal information of the user is accessed. The personal information of the user is used in determining the email address of the user from the speech of the user. In one preferred embodiment, the email address of the user is determined by generating a plurality of candidate email addresses based on the personal information of the user, comparing the speech of the user with each of the candidate email addresses, and selecting a best matching one of the candidate email addresses as the email address of the user.

### BACKGROUND OF THE INVENTION

1. Field of the Invention

The present invention relates to the field of voice recognition and, more specifically, to the voice recognition of email addresses.

2. Description of Related Art

The use of voice recognition systems is on the rise. As computing power increases and voice recognition techniques improve, the capabilities of voice recognition systems are growing. Voice recognition systems typically consist of a Voice Recognition Unit (VRU), also known as Automatic Speech Recognition (ASR), and a Voice User Interface (VUI). A VRU performs the functions necessary for recognizing speech and transforming it into useful information. A VUI is the interface that is experienced by the speech provider, whether it be via a telephone, web site or some other interface. VUIs are used for computer interfaces, identification systems and automated telephone systems.

As companies move towards reducing operating costs, the need for automated telephone systems has increased. One exemplary automated telephone system uses a voice recognition system to allow product purchasing. A user connects to a VUI via a telephone and purchases products using normal speech. In this example, the user is steered through the product purchasing process by the VUI and interacts with the VUI using speech. A piece of information that is commonly requested by such product purchasing systems is the user's email address. In response to such a request, the user provides an email address by speaking the email address into the telephone. A VRU then attempts to recognize the user's speech using conventional voice recognition techniques.

Current voice recognition techniques, however, do not come without drawbacks. Noise in the user's environment can hamper the ability of the VRU to accurately recognize what is spoken. This problem is compounded in a telephone environment by the fact that most telephones do not have high quality microphones for picking up a wide range of sounds. In addition, conventional telephone systems do not transmit the high frequency components of a person's speech. Furthermore, most VRUs are trained for speech from a native born American speaking English. If the user speaks with a foreign accent, this hampers the ability of the VRU to perform. It is also very difficult for a VRU to distinguish between similar-sounding short utterances such as “b,” “d,” “e” and “v.” This difficulty seriously hampers the ability of the VRU to recognize an email address that is spoken by a user. More specifically, there is often no discernible word pattern to which an email address conforms, so users are frequently required to spell out email addresses that do not correspond to known words or alphanumeric patterns. This requirement for spelling out email addresses, when coupled with the difficulty the VRU has in properly recognizing short utterances, causes the VRU to have little success in recognizing email addresses though speech.

Accordingly, there exists a need for a voice recognition technique that provides for effective and accurate recognition of a user's spoken email address.

### SUMMARY OF THE INVENTION

It is an object of the present invention to overcome the above-mentioned drawbacks and to provide systems, methods and computer program products for improving voice recognition of email addresses. In a preferred embodiment of the present invention, a user is prompted for an email address. The user speaks the email address into a device such as a telephone. Previously stored personal information of the user is accessed, and a list of email address candidates is generated from the personal information of the user. A grammar including each of the email candidates is generated, and for each email address candidate a list of possible pronunciations is then generated. The spoken email address is compared to the possible pronunciations for the email address candidates. The candidate email address corresponding to the possible pronunciation that is the best match with the spoken email address is selected.

Another object of the present invention is to increase the accuracy of a voice recognition system. The personal information of a user is used as an additional factor to consider when processing the user's speech. This feature supplements the accuracy of the voice recognition system. Furthermore, the use of the personal information of the user as an additional factor allows a non-speech factor to be used during comparison. This supplements accuracy by broadening the pool from which the comparison factors are taken.

Yet another object of the present invention is to increase the efficiency of a voice recognition system. The use of a user's personal information as an additional factor to consider during comparison increases the speed with which a VUI arrives at the selection of an email address.

Yet another object of the present invention is to decrease the probability of false acceptances and false rejections. A false acceptance occurs when a VRU incorrectly accepts speech as a match. Likewise, a false rejection occurs when a VRU incorrectly rejects speech for a match. As the accuracy of the voice recognition system is increased by the use of the personal information of a user, the probability of false acceptances and false rejections decreases. This leads to an increase in the overall efficiency of the voice recognition system.

Other objects, features, and advantages of the present invention will become apparent from the following detailed description. It should be understood, however, that the detailed description and specific examples, while indicating preferred embodiments of the present invention, are given by way of illustration only and various modifications may naturally be performed without deviating from the present invention.

### BRIEF DESCRIPTION OF THE DRAWINGS

The features and advantages of the present invention will become more apparent from the detailed description set forth below when taken in conjunction with the drawings in which like reference numbers indicate identical or functionally similar elements.

FIG. 1 is a block diagram illustrating the overall system architecture of one embodiment of the present invention.

FIG. 2 is a flowchart depicting the general operation and control flow of a process of a preferred embodiment of the present invention.

FIG. 3 is a block diagram illustrating the inputs and outputs of a conventional voice recognition application.

FIG. 4 is a block diagram illustrating the inputs and outputs of a voice recognition application according to one embodiment of the present invention.

FIG. 5 is a chart showing personal information of a user according to one exemplary embodiment of the present invention.

FIG. 6 is a flowchart depicting the operation and control flow of an email address voice recognition process according to one embodiment of the present invention.

FIG. 7 is a block diagram of an exemplary computer system useful for implementing the present invention.

### DETAILED DESCRIPTION OF PREFERRED EMBODIMENTS

1. Overview of the System

The present invention will now be described in terms of the exemplary embodiments below. This is for convenience only and is not intended to limit the application of the present invention. In fact, after reading the following description, it will be apparent to one of ordinary skill in the relevant art how to implement the present invention in alternative embodiments.

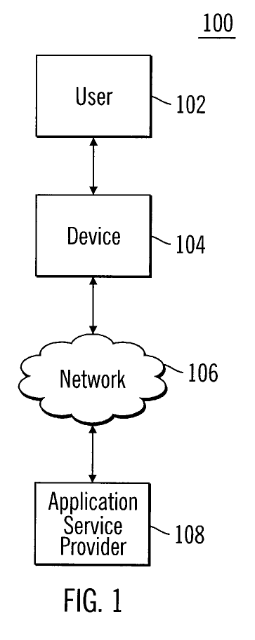

FIG. 1 is a block diagram illustrating the overall system architecture of an embodiment of the present invention. FIG. 1 is a generalized embodiment of the present invention illustrating an Application Service Provider (ASP) model of the present invention. This model represents a method by which an entity (the ASP) separate from a client provides a service to the client, typically in exchange for a fee. The system 100 includes a user 102, a device 104, a network 106 and an ASP 108. User 102 is a person that is using device 104 to access the services of ASP 108 via network 106.

In one embodiment of the present invention, network 106 is a circuit-switched network such as a Public Switched Telephone Network (PSTN), which is also known as the Plain Old Telephone System (POTS). In another embodiment of the present invention, network 106 is a packet-switched public wide area network (WAN) such as the global Internet. Network 106 can alternatively be a private WAN, a local area network (LAN), a telecommunications network or any combination of the above-mentioned networks. Network 106 can be wired, wireless, broadcast or point-to-point.

In embodiments in which network 106 is a PSTN, user device 104 is a telephone-capable device for sending and receiving audio signals. In preferred embodiments of the present invention, device 104 is an ordinary telephone or a mobile/cell phone. In further embodiments of the present invention, device 104 can be a personal computer (PC) (e.g., an IBM or compatible PC workstation running the Microsoft Windows operating system, a Macintosh computer running the Mac OS operating system, or the like), a Personal Digital Assistant (PDA) (e.g., a PalmPilot running the Palm OS operating system), a game console (e.g., a Sega Dreamcast console or a Sony Playstation 2 console), an interactive television, or any other communication device. In embodiments in which network 106 is a packet-switched network such as the Internet, user device 104 is a network-capable device for sending and receiving audio signals. For example, device 104 can be a PC, a PDA, a game console, interactive television or any other network-capable processing device able to communicate via the network 106.

ASP 108 includes a voice recognition system that includes a VRU and a VUI. The VRU, which may be implemented in hardware, software or any combination of the two, performs the functions necessary for recognizing speech and transforming it into useful information. The VRU is described in greater detail below. ASP 108 can also include a database for storing and retrieving information. In one exemplary embodiment of the present invention, the database is used to store personal information pertaining to user 102, pronunciation statistics defining how tokens are pronounced and a pronunciation dictionary for defining how to pronounce words and phrases. In another embodiment of the present invention, the database is also used to store email address algorithms for defining how to create email addresses from a user's personal information and grammars generated during voice recognition of email addresses. In addition, the database can be used to store any other information that is required by the applications running on ASP 108. In preferred embodiments, the database is a commercially available database system implemented in hardware, software or any combination of the two. In other embodiments of the present invention, the database is Random Access Memory associated with the computer system of ASP 108.

In one embodiment of the present invention, ASP 108 is one or more SUN Ultra workstations running the SunOS operating system. In another embodiment of the present invention, ASP 108 is one or more IBM or compatible PC workstations running either the Windows operating system or the BSD Unix operating system. ASP 108 is connected to network 106 which serves as the communications medium between ASP 108 and its clients (e.g., user device 104). While only one user 102 and only one device 104 are shown in FIG. 1 for ease of explanation, the system 100 preferably supports any number of users 102 and devices 104.

In some embodiments of the present invention, network 106 is not provided. This scenario represents a non-network model of the present invention in which the user 102 interacts directly with ASP 108 through device 104 (e.g., a microphone).

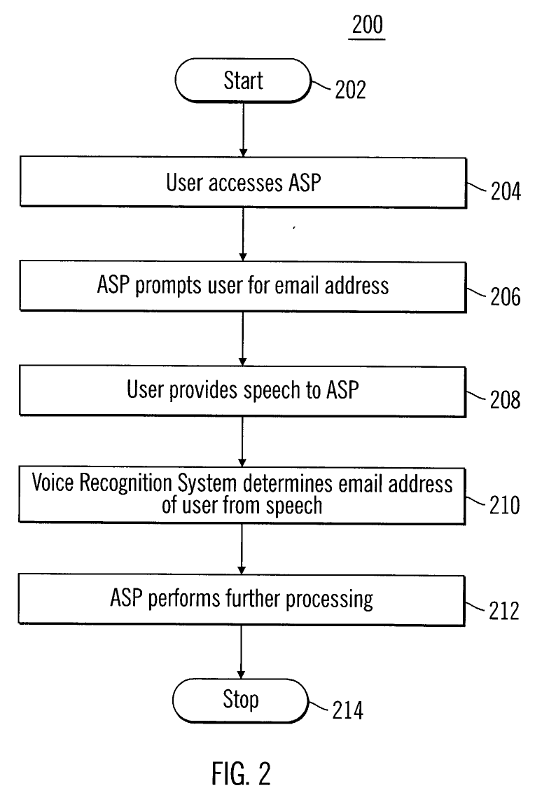

More detailed descriptions of the components of system 100, as well as their functionality and inter-functionality with other components, are provided below. The operation of the system of FIG. 1 according to one embodiment of the present invention is shown in the flowchart of FIG. 2.

2. General Operation of the System

Generally, system 100 represents a technique for improving voice recognition when a user 102 audibly provides an email address. FIG. 2 is a flowchart depicting the operation and control flow 200 of a preferred embodiment of the present invention. In this embodiment, a product ordering system is described for illustrative purposes. In the example described below, a user 102 orders a product from a merchant via a telephone. During the described process, the product ordering system prompts the user 102 for his email address. The name of user 102 in the example below is “John White” and he works at “Big Company.” Control flow 200 begins with step 202 and flows directly to step 204.

In step 204, user 102 accesses ASP 108 via user device 104. In this example, user 102 uses a telephone (device 104) and calls the merchant (ASP 108) over a POTS line (network 106). In step 206, ASP 108 prompts the user 102 for an email address. In this example, the user 102 hears, “Please tell me your email address.” In step 208, the user 102 provides speech representing his email address to ASP 108 over device 104. In this example, the user 102 says, “‘J’ White At Big Company Dot Com” into the telephone. This corresponds to an email address of “jwhite@bigcompany.com”.

In step 210, the voice recognition system of ASP 108, using voice recognition techniques, determines the email address of user 102 based on his speech. The determination is also based on previously stored personal information of user 102, pronunciation statistics defining how tokens are pronounced, email address algorithms for defining how to create an email address from a user's personal information, grammars generated for voice recognition of email addresses, and, optionally, a pronunciation dictionary for defining how to pronounce words and phrases. In addition, the determination can be based on any other information or factors that may be useful in the voice recognition of email addresses. In this example, the voice recognition system of ASP 108 receives the speech of the user 102 and, using voice recognition techniques, determines that his email address is “jwhite@bigcompany.com”. The email address voice recognition operation is described in greater detail below. In step 212, ASP 108 performs further processing for the user 102. In this example, ASP 108 completes the ordering process with the user 102. This may include taking additional information such as the billing or shipping address of the user 102. In step 214, control flow 200 ceases. Step 210 of control flow 200 is described in greater detail below.

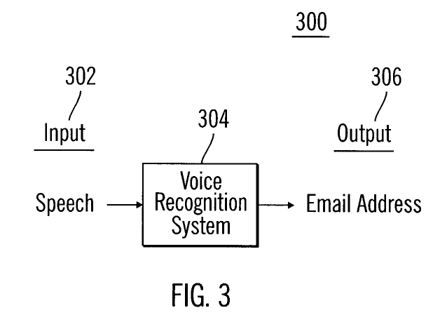

FIG. 3 is a block diagram 300 illustrating the input and output of a conventional voice recognition system, which typically includes a VUI, a VRU, and other elements (e.g., a TTS engine and a web server). Diagram 300 shows a voice recognition system 304 for recognizing an email address that is audibly provided by the user 102. Diagram 300 also shows the input 302 and the output 306 involved when voice recognition system 304 performs its operations.

Voice recognition system 304 receives speech from user 102 as input 302. The input 302 is typically stored as an audio recording or as an audio signature data file representing the recording. An audio signature data file is a file containing data which uniquely represents an audio file, such as a frequency chart. Alternatively, certain relevant characteristics of the input 302, as opposed to the input itself, are extracted and stored. The output 306 of voice recognition system 304 is an email address. An email address is typically a string of characters, and can be stored as a string, file or record which represents the email address.

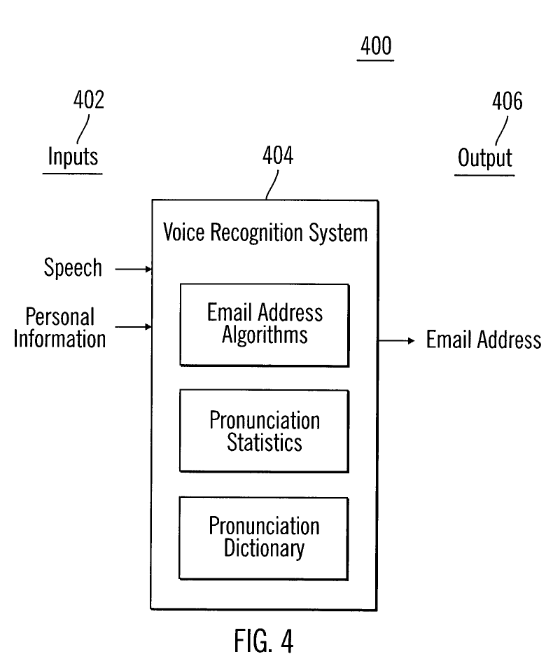

FIG. 4 is a block diagram 400 illustrating the input and output of an email address voice recognition system 404 according to one embodiment of the present invention. Diagram 400 shows a voice recognition system 404, which includes a VUI and a VRU, for recognizing an email address that is audibly provided by the user 102. Diagram 400 also shows the inputs 402 and the output 406 involved when voice recognition system 404 performs the email address voice recognition operation. The email address voice recognition operation is described in greater detail below. Diagram 400 roughly corresponds to the function performed in a preferred embodiment of the present invention in step 210 of FIG. 2.

Voice recognition system 404 receives speech from the user 102 as an input 402. The speech input 402 can be stored as an audio recording, an audio signature data file, or in the form of certain relevant characteristics of the input 402. Voice recognition system 404 also receives as an input 402 some personal information of the user 102. The personal information is described in greater detail below. The personal information of the user 102 can be stored as a file, a record or a group of files or records, or can just be temporarily held in memory.

Voice recognition system 404 includes one or more email address algorithms for defining how to create email addresses from a user's personal information. Email address algorithms are typically based on statistical analysis of the manner in which people use personal information to create an email address. Email address algorithms can be implemented in hardware, software, or any combination of the two. An email address algorithm uses the personal information of a user to generate one or more email addresses. For example, an email address algorithm can use the first and last names of a user, such as “John White,” and the name of the user's company, such as “Big Company.” The email address algorithms define how such information should be used to produce email addresses. Below is the pseudo-code for three exemplary email address algorithms.

Full-First-Name+Full-Last-Name+“@”+Company-Name+“.com”

First-Name-Initial+Full-Last-Name+“@”+Company-Name+“.com”

Full-First-Name+Last-Name-Initial+“@”+Company-Name+“.com”

The execution of the above email address algorithms on the personal information above results in the following email addresses.

johnwhite@bigcompany.com

jwhite@bigcompany.com

johnw@bigcompany.com

Voice recognition system 404 also includes pronunciation statistics for defining how tokens are pronounced. A token is a letter, number, word or phrase. The pronunciation statistics define how people typically pronounce these tokens. Based on these pronunciation statistics, the voice recognition system 404 determines the pronunciation of candidate email addresses. This function is described in greater detail below. Pronunciation statistics can be stored as a file, a record or a group of files or records. In one embodiment of the present invention, pronunciation statistics are stored in a database that is accessible to the voice recognition system 404.

In preferred embodiments of the present invention, voice recognition system 404 also includes a pronunciation dictionary for defining how to pronounce words and phrases. A pronunciation dictionary is a collection of phrases, words, or letters together with corresponding pronunciations for each. For example, the word “often” could be found in a pronunciation dictionary with the corresponding pronunciations “OFF-TIN” and “OFF-IN.” A pronunciation dictionary may be implemented in hardware, software, or any combination of the two. A pronunciation dictionary can be stored as a file, a record or a group of files or records. In one embodiment of the present invention, a pronunciation dictionary is stored in a database that is accessible to the voice recognition system 404.

The output 406 of voice recognition system 404 is an email address. An email address is typically a string of characters and can be stored as a string, file or record which represents the email address.

3. Personal User Information

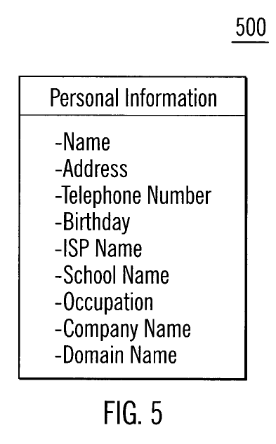

FIG. 5 is a chart 500 showing exemplary personal information for a user according to one embodiment of the present invention. As explained above with respect to step 210 of FIG. 2, the email address voice recognition operation of the present invention involves the use of personal information pertaining to the user 102. The personal information of user 102 is stored in the database of ASP 108, or temporarily held in a file or memory, as a result of various scenarios. In one case, the user 102 previously interacted with ASP 108 and submitted personal information to ASP 108. In another case, the personal information of the user 102 was sent to ASP 108 from a third party with whom the user 102 had interaction in the past. In yet another case, the user 102 gave personal information to ASP 108 during the very process of control flow 200. For example, the user 102 could have submitted some or all of the personal information in a cookie, via a “Microsoft Wallet” transaction or by entering the personal information using a user interface (e.g., through speech or typing). The stored personal information of the user 102 is accessed by VRU 404 during the email address voice recognition process, which is described in greater detail below.

The email address voice recognition operation of the present invention involves the use of personal information because a user's personal information is often utilized when the user creates an email address. That is, people often use their personal information or something derived from it in the text of their email addresses. For example, one of the most common schemes for creating an email address for a worker at a company is: First-Name-Initial+Full-Last-Name+“@”+Company-Name+“.com”. Thus, for a user named “John White” who works at “Big Company,” there is a good likelihood that the email address for this user is “jwhite@bigcompany.com”. Users can also use other personal information in their email address such as birthdays, school names and occupations.

Chart 500 shows the following exemplary personal information that is used by ASP 108 during the email address recognition operation: name, address, telephone number, birthday, Internet Service Provider, school, occupation, company and domain name. In further embodiments of the present invention, chart 500 can also include any other personal information of a user.

4. Email Address Voice Recognition Operation

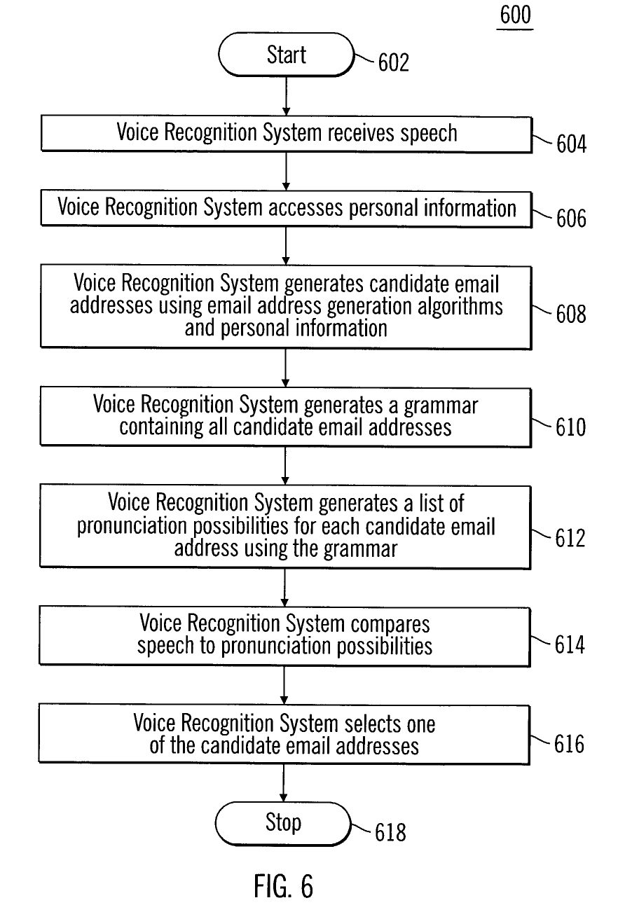

FIG. 6 is a flowchart depicting the operation and control flow 600 of the voice recognition process according to one embodiment of the present invention. Generally, the operation of control flow 600 corresponds to the function performed in step 210 of FIG. 2 and, more specifically, the function performed by voice recognition system 404 of FIG. 4. In this flowchart, the exemplary product ordering system and the exemplary user “John White” are used again. Control flow 600 begins with step 602 and flows directly to step 604.

In step 604, voice recognition system 404 receives speech from the user 102. As described above, the speech of the user 102 can be saved as an audio file, an audio signature data file or in the form of certain relevant characteristics of the speech. In this example, voice recognition system 404 receives the speech, “‘J’ White At Big Company Dot Com” from the user.

In step 606, voice recognition system 404 accesses the personal information of the user 102 from a database, file or memory. In this example, the user 102 (John White) had previously interacted with ASP 108 and submitted some personal information to ASP 108. Specifically, the user 102 had submitted to ASP 108 his first and last names, his company's name, and other personal information. ASP 108 has this personal information for the user 102 stored in its database. Therefore, ASP 108 accesses the following personal information for the user 102: First Name=“John,” Last Name=“White,” and Company Name=“Big Company.” This access can be active or passive on the part of voice recognition system 404.

In step 608, voice recognition system 404 accesses its email address algorithms (e.g., from the database of ASP 108). Voice recognition system 404 uses the personal information of user 102 as inputs to the email address algorithms. Using this personal information, the email address algorithms generate a list of candidate email addresses for the user 102. In this example, the accessed email address algorithms are as follows (in pseudo-code).

Full-First-Name+Full-Last-Name+“@”+Company-Name+“.com”

First-Name-Initial+Full-Last-Name+“@”+Company-Name+“.com”

Full-First-Name+Last-Name-Initial+“@”+Company-Name+“.com”

The execution of the above email address algorithms on the personal information of the user 102 results in the following candidate email addresses.

johnwhite@bigcompany.com

jwhite@bigcompany.com

johnw@bigcompany.com

In step 610, voice recognition system 404 generates a grammar encompassing each of the candidate email addresses. A grammar is a definition of all of the possible candidate email addresses that the voice recognition system 404 should expect. Thus, the grammar generated in step 610, is based on the candidate email addresses generated in step 608. In one embodiment, the grammar is in Bachus-Nauer Format (BNF). An example of a BNF grammar encompassing each of the candidate email addresses generated above is shown below.

Email Address=[First Name Token][Last Name Token][@][Company Name Token][.][com]

This grammar encompasses each of the candidate email addresses in this example.

In some embodiments of the present invention, certain grammars generated in step 610 are weighted to reflect statistical analyses of email addresses. As described above, certain email address combinations are more common than others. For example, the following email address combination is widely used by people working for a company that offers email service: First-Name-Initial +Full-Last-Name+@+Company-Name+“.com”. As a result, there is a good likelihood that this type of email address will be provided by a user 102 that is prompted to provide an email address. For this reason, the grammar generated in step 610 can be weighted so that such common email address combinations result in a high confidence score. A high confidence score results in a better chance for a match between the user's speech and the pronunciation possibilities generated later in the process. The calculation of confidence scores and the generation of pronunciation possibilities are described in greater detail below.

In step 612, guided by the grammar generated in step 610, voice recognition system 404 generates pronunciations for the candidate email addresses generated in step 608. In one embodiment of the present invention, voice recognition system 404 accesses the pronunciation statistics in the database of ASP 108. Based on these statistics, voice recognition system 404 generates a list of pronunciation possibilities for each candidate email address, guided by the grammar generated in step 610. In another embodiment of the present invention, voice recognition system 404 accesses rule-based pronunciation guidelines in the database of ASP 108. Based on these guidelines, voice recognition system 404 generates a list of pronunciation possibilities for each candidate email address, guided by the grammar generated in step 610.

In yet another embodiment of the present invention, voice recognition system 404 accesses the pronunciation dictionary in the database of ASP 108. The pronunciation dictionary in the database of ASP 108 can be the user's dictionary, a system dictionary or any other dictionary to which the voice recognition system 404 has access. Then, voice recognition system 404, employing one or more pronunciation dictionaries, generates a list of pronunciation possibilities for each candidate email address, guided by the grammar generated in step 610. Optionally, new pronunciations generated by voice recognition system 404 can be added to one of the pronunciation dictionaries (e.g., the user's dictionary).

In this example, voice recognition system 404 accesses pronunciation statistics and, using the corresponding grammar generated above, determines a list of pronunciation possibilities for each of the generated candidate email addresses. For example, for the “jwhite@bigcompany.com” candidate email address, voice recognition system 404 determines from the pronunciation statistics and the grammar the following pronunciation possibility: “‘J’ White At Big Company Dot Com.”

In step 614, voice recognition system 404 compares the speech of the user 102 to the pronunciation possibilities for the candidate email addresses. This function can be performed using conventional voice recognition techniques, such as those implemented in commercially available software products. One example of such a commercially available software product is Open Speech Recognizer 1.0 available from SpeechWorks, Inc. of Boston Mass. This commercially available software product has the capability to compare user speech with a given item and provide the degree of similarity between the two.

In one embodiment of the present invention, in the comparing step 614, a confidence score is calculated for each pronunciation possibility. The confidence score represents the estimated accuracy of the match between the user's speech and that pronunciation possibility. For example, a confidence score can be a percentage from 0% to 100%, (with 100% representing almost perfect accuracy), or a number from 0 to 999 (with 999 representing almost perfect accuracy). A higher confidence score indicates that the voice recognition system 404 is more certain that there is a match. A lower confidence score indicates that the voice recognition system 404 is less certain that there is a match. The generation of a confidence score can be performed using conventional voice recognition techniques, such as those implemented in the commercially available software products described above. In this example, the confidence score of one of the pronunciation possibilities corresponding to the “jwhite@bigcompany.com” candidate email address comes out as the highest confidence score because of the high degree of similarity between the user's speech and this pronunciation possibility.

In step 616, voice recognition system 404 selects the candidate email address that is the best match to the user's speech. In one embodiment of the present invention, voice recognition system 404 selects the candidate email address corresponding to the pronunciation possibility with the highest confidence score. In another embodiment of the present invention, voice recognition system 404 selects the candidate email address corresponding to the pronunciation possibility with the highest confidence score, only if that confidence score reaches a minimum threshold. In this embodiment, in the event that there are no pronunciation possibilities that exceed the minimum threshold, control flows back to step 604 in order to receive additional speech from the user 102. Alternatively, if the threshold is not reached for any of the candidate email addresses, voice recognition system 404 could then use conventional voice recognition techniques or some other process (e.g., keyboard entry) to obtain the user's email address. In step 618, control flow 600 ceases.

The email address voice recognition operation of the present invention is advantageous because it provides for accurate and efficient recognition of email addresses. It is known that most people base their email addresses on personal information such as their first and last names. For this reason, the email address voice recognition operation of the present invention uses personal information of the user to create a list of candidate email addresses to be compared with the user's spoken email address. Thus, a limited set of probable email addresses for the user is set up. This results in a more accurate and user-friendly email address voice recognition system.

5. Exemplary Implementations

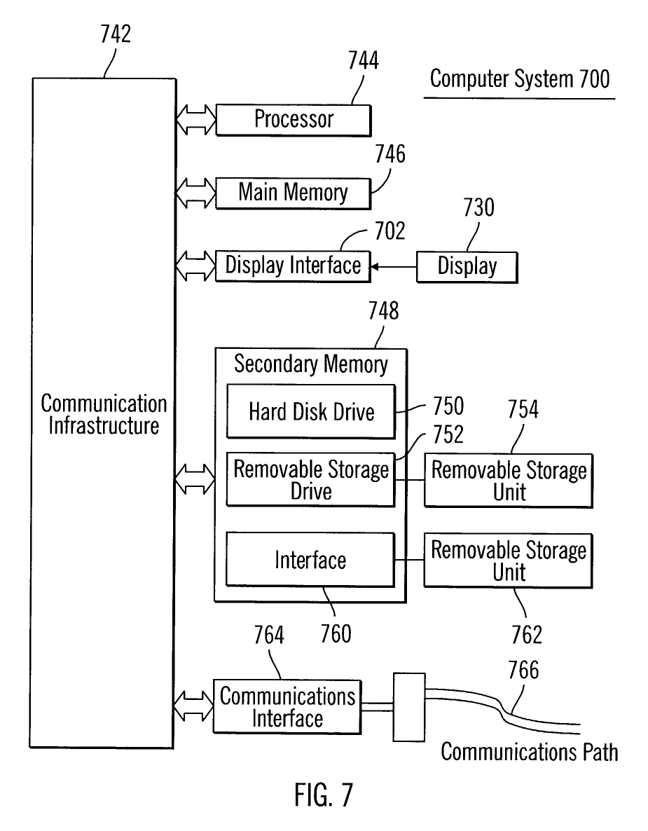

The present invention (e.g., system 100, flow 200, diagram 300, diagram 400 and flow 600 or any part thereof) may be implemented using hardware, software or a combination thereof, and may be implemented in one or more computer systems or other processing systems. An example of such a computer system is shown in FIG. 7. The computer system 700 represents any single or multi-processor computer. In conjunction, single-threaded and multi-threaded applications can be used. Unified or distributed memory systems can be used. Computer system 700, or portions thereof, may be used to implement the present invention. For example, the flow 200 of the present invention may comprise software running on a computer system such as computer system 700.

In one example, flow 200 of the present invention is implemented in a multi-platform (platform independent) programming language such as JAVA, programming language/structured query language (PL/SQL), hyper-text mark-up language (HTML), practical extraction report language (PERL), Flash programming language, common gateway interface/structured query language (CGI/SQL) or the like. Java-enabled and JavaScript-enabled browsers are used, such as Netscape, HotJava, and Microsoft Internet Explorer browsers. Active content Web pages can be used. Such active content Web pages can include Java applets or ActiveX controls, or any other active content technology developed now or in the future. The present invention, however, is not intended to be limited to Java, JavaScript, or their enabled browsers, and can be implemented in any programming language and browser, developed now or in the future.

In another example, system 100 of the present invention, may be implemented using a high-level programming language (e.g., C++) and applications written for the Microsoft Windows or SUN OS environments. It will be apparent to a person of ordinary skill in the relevant art how to implement the present invention in alternative embodiments from the teachings herein.

Computer system 700 includes one or more processors, such as processor 744. One or more processors 744 can execute software implementing the routines described above, such as those shown in FIGS. 2-4 and 6. Each processor 744 is connected to a communication infrastructure 742 (e.g., a communications bus, cross-bar, or network). Various software embodiments are described in terms of this exemplary computer system. In further embodiments, the present invention is implemented using other computer systems and/or computer architectures.

Computer system 700 can include a display interface 702 that forwards graphics, text, and other data from the communication infrastructure 742 (or from a frame buffer) for display on the display unit 730.

Computer system 700 also includes a main memory 746, preferably random access memory (RAM), and can also include a secondary memory 748. The secondary memory 748 can include, for example, a hard disk drive 750 and/or a removable storage drive 752 (such as a floppy disk drive, a magnetic tape drive, an optical disk drive, or the like). The removable storage drive 752 reads from and/or writes to a removable storage unit 754 in a conventional manner. Removable storage unit 754 represents a floppy disk, magnetic tape, optical disk, or the like, which is read by and written to by removable storage drive 752. The removable storage unit 754 includes a computer usable storage medium having stored therein computer software and/or data.

In alternative embodiments, secondary memory 748 may include other similar means for allowing computer programs or other instructions to be loaded into computer system 700. Such means can include, for example, a removable storage unit 762 and an interface 760. Examples can include a program cartridge and cartridge interface (such as that found in video game console devices), a removable memory chip (such as an EPROM or PROM) and associated socket, and other removable storage units 762 and interfaces 760 which allow software and data to be transferred from the removable storage unit 762 to computer system 700.

Computer system 700 can also include a communications interface 764. Communications interface 764 allows software and data to be transferred between computer system 700 and external devices via communications path 766. Examples of communications interface 764 can include a modem, a network interface (such as an Ethernet card), a communications port, other interfaces described above, and the like. Software and data transferred via communications interface 764 are in the form of signals which can be electronic, electromagnetic, optical or other signals capable of being received by communications interface 764, via communications path 766. Note that communications interface 764 provides a means by which computer system 700 can interface to a network such as the Internet.

The present invention can be implemented using software executing in an environment similar to that described above with respect to FIGS. 2-4 and 6. The term “computer program product” includes a removable storage unit 754, a hard disk installed in hard disk drive 750, or a carrier wave carrying software over a communication path 766 (wireless link or cable) to communication interface 764. A “machine readable medium” can include magnetic media, optical media, semiconductor memory or other recordable media, or media that transmits a carrier wave or other signal. These computer program products are means for providing software to computer system 700.

Computer programs (also called computer control logic) are preferably stored in main memory 746 and/or secondary memory 748. Computer programs can also be received via communications interface 764. Such computer programs, when executed, enable the computer system 700 to perform the features of the present invention as discussed herein. In particular, the computer programs, when executed, enable the processor 744 to perform features of the present invention. Accordingly, such computer programs represent controllers of the computer system 700.

The present invention can be implemented as control logic in software, firmware, hardware or any combination thereof. In an embodiment in which the present invention is implemented using software, the software may be stored on a computer program product and loaded into computer system 700 using removable storage drive 752, hard disk drive 750, or interface 760. Alternatively, the computer program product may be downloaded to computer system 700 over communications path 766. The control logic (e.g., software), when executed by one or more processors 744, causes the processor(s) 744 to perform functions of the present invention as described herein.

In another embodiment, the present invention is implemented primarily in firmware and/or hardware using, for example, hardware components such as application specific integrated circuits (ASICs). A hardware state machine is implemented so as to perform the functions described herein.

While there has been illustrated and described what are presently considered to be the preferred embodiments of the present invention, it will be understood by those skilled in the art that various other modifications may be made, and equivalents may be substituted, without departing from the true scope of the present invention. Additionally, many modifications may be made to adapt a particular situation to the teachings of the present invention without departing from the central inventive concept described herein. Furthermore, an embodiment of the present invention may not include all of the features described above. Therefore, it is intended that the present invention not be limited to the particular embodiments disclosed, but that the invention include all embodiments falling within the scope of the appended claims.

What is claimed is:

1. A method for automated voice recognition of an email address of a user, said method comprising the steps of:
receiving speech representing the email address of the user;
accessing personal information of the user; and
using the personal information of the user in determining the email address of the user from the speech of the user.

2. The method of claim 1, wherein the step of using the personal information of the user in determining the email address includes the sub-steps of:
generating a plurality of candidate email addresses based on the personal information of the user;
comparing the speech of the user with each of the candidate email addresses; and
selecting a best matching one of the candidate email addresses as the email address of the user.

3. The method of claim 1, wherein the step of using the personal information of the user in determining the email address includes the sub-steps of:
generating a plurality of candidate email addresses based on the personal information of the user;
generating at least one pronunciation possibility for each of the candidate email addresses;
comparing the speech of the user with each of the pronunciation possibilities; and
selecting one of the candidate email addresses as the email address of the user based on the comparison.

4. The method of claim 3, wherein the sub-step of selecting one of the candidate email addresses includes:
generating a confidence score for each of the pronunciation possibilities for each of the candidate email addresses, the confidence score being indicative of a degree of similarity between the speech of the user and one of the pronunciation possibilities; and
selecting the candidate email address having the highest confidence score.

5. The method of claim 3, wherein the sub-step of generating a plurality of candidate email addresses includes:
using a plurality of email address generating algorithms to generate the candidate email addresses, each of the email address generating algorithms using some of the personal information of the user to form one of the candidate email addresses.

6. The method of claim 3, wherein the sub-step of generating at least one pronunciation possibility for each of the candidate email addresses includes:
parsing each of the candidate email addresses into a plurality of elements;
using a pronunciation dictionary to generate at least one pronunciation for each element of each of the candidate email addresses; and
generating a plurality of pronunciation possibilities for each of the candidate email addresses, each pronunciation possibility being a combination of pronunciations for the elements of one of the candidate email addresses.

7. The method of claim 3, wherein the sub-step of generating at least one pronunciation possibility for each of the candidate email addresses includes:
generating a grammar containing all of the candidate email addresses; and
using the grammar and a pronunciation dictionary to generate a plurality of pronunciation possibilities for each of the candidate email addresses.

8. The method of claim 1, wherein the step of accessing the personal information of the user includes the sub-step of:
prompting the user to provide the personal information; and
receiving the personal information of the user through speech of the user.

9. The method of claim 1, wherein the step of accessing the personal information of the user includes the sub-step of retrieving the personal information of the user from a database.

10. A machine-readable medium encoded with a program for automated voice recognition of an email address of a user, said program containing instructions for performing the steps of:
receiving speech representing the email address of the user;
accessing personal information of the user; and
using the personal information of the user in determining the email address of the user from the speech of the user.

11. The machine-readable medium of claim 10, wherein the step of using the personal information of the user in determining the email address includes the sub-steps of:
generating a plurality of candidate email addresses based on the personal information of the user;
comparing the speech of the user with each of the candidate email addresses; and
selecting a best matching one of the candidate email addresses as the email address of the user.

12. The machine-readable medium of claim 10, wherein the step of using the personal information of the user in determining the email address includes the sub-steps of:
generating a plurality of candidate email addresses based on the personal information of the user;
generating at least one pronunciation possibility for each of the candidate email addresses;
comparing the speech of the user with each of the pronunciation possibilities; and
selecting one of the candidate email addresses as the email address of the user based on the comparison.

13. The machine-readable medium of claim 12, wherein the sub-step of generating a plurality of candidate email addresses includes:
using a plurality of email address generating algorithms to generate the candidate email addresses, each of the email address generating algorithms using some of the personal information of the user to form one of the candidate email addresses.

14. The machine-readable medium of claim 12, wherein the sub-step of generating at least one pronunciation possibility for each of the candidate email addresses includes:
parsing each of the candidate email addresses into a plurality of elements;
using a pronunciation dictionary to generate at least one pronunciation for each element of each of the candidate email addresses; and
generating a plurality of pronunciation possibilities for each of the candidate email addresses, each pronunciation possibility being a combination of pronunciations for the elements of one of the candidate email addresses.

15. The machine-readable medium of claim 12, wherein the sub-step of generating at least one pronunciation possibility for each of the candidate email addresses includes:
generating a grammar containing all of the candidate email addresses; and
using the grammar and a pronunciation dictionary to generate a plurality of pronunciation possibilities for each of the candidate email addresses.

16. The machine-readable medium of claim 10, wherein the step of accessing the personal information of the user includes the sub-step of retrieving the personal information of the user from a database.

17. An automated voice recognition system comprising:
a first input for receiving speech representing the email address of the user;
a second input for receiving personal information of the user; and
a comparator for outputting an email address of the user based on the first and second inputs.

18. The automated voice recognition system of claim 17, further comprising:
a candidate email address generator for generating a plurality of candidate email addresses based on the personal information of the user,
wherein the comparator compares the speech of the user with each of the candidate email addresses and selects a best matching one of the candidate email addresses as the email address of the user.

19. The automated voice recognition system of claim 17, further comprising:
a candidate email address generator for generating a plurality of candidate email addresses based on the personal information of the user; and
a pronunciation generator for generating at least one pronunciation possibility for each of the candidate email addresses,
wherein the comparator compares the speech of the user with each of the pronunciation possibilities and selects one of the candidate email addresses as the email address of the user based on the comparison.

20. The automated voice recognition system of claim 19, wherein the candidate email address generator uses a plurality of email address generating algorithms to generate the candidate email addresses, each of the email address generating algorithms using some of the personal information of the user to form one of the candidate email addresses.

21. The automated voice recognition system of claim 19, wherein the pronunciation generator parses each of the candidate email addresses into a plurality of elements, uses a pronunciation dictionary to generate at least one pronunciation for each element of each of the candidate email addresses, and generates a plurality of pronunciation possibilities for each of the candidate email addresses, each pronunciation possibility being a combination of pronunciations for the elements of one of the candidate email addresses.

22. The automated voice recognition system of claim 19, further comprising:
a grammar generator for generating a grammar containing all of the candidate email addresses,
wherein the pronunciation generator uses the grammar and a pronunciation dictionary to generate a plurality of pronunciation possibilities for each of the candidate email addresses.

23. The automated voice recognition system of claim 17, further comprising a database for storing the personal information of the user.
